(19) United States
(12) Patent Application Publication
(10) Pub. No.: US 2016/0068193 A1
(43) Pub. Date: Mar. 10, 2016

(54) VEHICLE FRONT SECTION STRUCTURE

(71) Applicant: TOYOTA JIDOSHA KABUSHIKI KAISHA, Toyota-shi (JP)

(72) Inventor: Hiroyuki KOIKE, Toyota-shi (JP)

(73) Assignee: TOYOTA JIDOSHA KABUSHIKI KAISHA, Toyota-shi (JP)

(21) Appl. No.: 14/848,915

(22) Filed: Sep. 9, 2015

(30) Foreign Application Priority Data
Sep. 10, 2014 (JP) 2014-184070

(51) Int. Cl. B62D 21/15; B62D 27/02; B62D 29/04; B62D 21/11

(52) U.S. Cl. CPC B62D 21/152; B62D 21/11; B62D 27/02; B62D 29/04

(57) ABSTRACT

There is provided a vehicle front section structure, the structure comprising a first member that is configured from a metal material, that is formed in a hollow rectangular column shape, and that is disposed with a length direction along a vehicle front-rear direction at a front section of a vehicle; a second member that is configured from a metal material, that extends along the vehicle front-rear direction at a vehicle rear side of the first member, and that has a front end portion fixed to a rear end portion of the first member; and a stopper that is provided at the second member, that is disposed facing a rear end of the first member along the vehicle front-rear direction, and that covers at least one corner portion of the first member from the vehicle rear side.

### CROSS-REFERENCE TO RELATED APPLICATION

This application claims priority under 35 USC 119 from Japanese Patent application No. 2014-184070 filed on Sep. 10, 2014, the disclosure of which is incorporated by reference herein.

### BACKGROUND

1. Technical Field

The present disclosure relates to a vehicle front section structure.

2. Related Art

In a vehicle front section structure described in Japanese Patent Application Laid-Open (JP-A) No. 2014-004943, an extension member (second member) is provided at a vehicle rear side of a front side member (first member). A rear end portion of the front side member and a leading end portion of the extension member are respectively joined to a dash panel to place the dash panel in an interposed state therebetween. Accordingly, collision load toward the vehicle rear side that is input to the front side member in a front-on collision of the vehicle is transmitted through the dash panel to the extension member.

However, the vehicle front section structure described in JP-A No. 2014-004943 leaves room for improvement in the following respect. Namely, when collision load is input to the front side member, the collision load is mainly transmitted toward the vehicle rear side along ridge lines formed at corner portions of the front side member. Accordingly, in order to efficiently transmit the collision load input to the front side member to the extension member, it is desirable for the collision load running along the ridge lines of the front side member to be transmitted to the extension member. However, JP-A No. 2014-004943 makes no mention of this point. Accordingly, in the vehicle front section structure described above, there is still room for improvement with respect to efficiently transmitting collision load that is input to the front side member (first member) in a front-on collision of the vehicle to the extension member (second member).

### SUMMARY

In consideration of the above circumstances, the present disclosure provides a vehicle front section structure capable of efficiently transmitting collision load input to a first member to a second member in a front-on collision.

A first aspect of the present disclosure is a vehicle front section structure including a first member that is configured from a metal material, that is formed in a hollow rectangular column shape, and that is disposed with a length direction along a vehicle front-rear direction at a front section of a vehicle, a second member that is configured from a metal material, that extends along the vehicle front-rear direction at a vehicle rear side of the first member, and that has a front end portion fixed to a rear end portion of the first member, and a stopper that is provided at the second member, that is disposed facing a rear end of the first member along the vehicle front-rear direction, and that covers at least one corner portion of the first member from the vehicle rear side.

In the vehicle front section structure of the first aspect, the first member that is formed in a hollow rectangular column shape is disposed with its length direction along the vehicle front-rear direction at the front section of the vehicle. The second member extends along the vehicle front-rear direction at the vehicle rear side of the first member, and the front end portion of the second member is fixed to the rear end portion of the first member. Accordingly, when collision load toward the vehicle rear side is input to the first member in a front-on collision of the vehicle, the collision load is transmitted to the second member. Further, when collision load is input to the first member, the collision load toward the vehicle rear side is transmitted toward the vehicle rear side mainly along ridge lines formed at the corner portions of the first member.

In this regard, the second member is provided with the stopper. The stopper is disposed facing the rear end of the first member along the vehicle front-rear direction, and covers at least one corner portion of the first member from the vehicle rear side. The stopper accordingly bears the collision load running along the ridge lines of the first member toward the vehicle rear side, thereby enabling good transmission of the collision load to the second member. Collision load input to the first member can accordingly be efficiently transmitted to the second member in a front-on collision.

A second aspect of the present disclosure is the vehicle front section structure of the first aspect, wherein the stopper covers every corner portion of the first member from the vehicle rear side.

In the vehicle front section structure of the second aspect, the stopper covers every corner portion of the first member from the vehicle rear side. This thereby enables collision load input to the first member to be even more efficiently transmitted to the second member in a front-on collision.

A third aspect of the present disclosure is the vehicle front section structure of either the first aspect or the second aspect, wherein the rear end of the first member abuts the stopper.

In the vehicle front section structure of the third aspect, the rear end of the first member abuts the stopper. This thereby enables collision load to be transmitted to the second member from an initial stage when collision load is input to the first member.

A fourth aspect of the present disclosure is the vehicle front section structure of any one of the first aspect to the third aspect, wherein the first member and the second member are joined together by MIG welding.

The vehicle front section structure of the fourth aspect enables good joining of the rear end portion of the first member that is formed in a hollow rectangular column shape to the front end portion of the second member.

A fifth aspect of the present disclosure is the vehicle front section structure of any one of the first aspect to the fourth aspect, wherein the second member is formed by die casting, and the stopper is integrally formed with the second member.

In the vehicle front section structure of the fifth aspect, the second member is formed by die casting, thereby enabling the stopper to be formed to the second member easily.

A sixth aspect of the present disclosure is the vehicle front section structure of any one of the first aspect to the fifth aspect, wherein the first member is formed by extrusion molding.

In the vehicle front section structure of the sixth aspect, collision load input to the first member can be efficiently transmitted to the second member in a front-on collision of the vehicle, even when the first member is formed by extrusion molding.

A seventh aspect of the present disclosure is the vehicle front section structure of any one of the first aspect to the sixth aspect, wherein the first member is configured by front side members disposed on both vehicle width direction sides of the front section of the vehicle, and the second member is configured by rear members extending along the vehicle front-rear direction so as to follow a dash panel partitioning between the front section of the vehicle and a vehicle cabin.

In the vehicle front section structure of the seventh aspect, the first member is configured by the front side members, and the second member is configured by the rear members. This thereby enables collision load input to the front side members to be efficiently transmitted to the rear members in a front-on collision of the vehicle.

An eighth aspect of the present disclosure is the vehicle front section structure of any one of the first aspect to the sixth aspect, wherein the first member is configured by a coupling member of a suspension member provided at the front section of the vehicle, the suspension member including a suspension member front portion and a suspension member rear portion, and the second member is configured by the suspension member rear portion, and wherein the suspension member front portion configuring a front portion of the suspension member, the suspension member rear portion configuring a rear portion of the suspension member, and the coupling member coupling the suspension member front portion and the suspension member rear portion together.

In the vehicle front section structure of the eighth aspect, the first member is configured by the coupling member, and the second member is configured by the suspension member rear portion. This thereby enables collision load input to the suspension member front portion to be efficiently transmitted to the suspension member rear portion in a front-on collision of the vehicle.

According to the vehicle front section structure of the first aspect, collision load input to the first member can be efficiently transmitted to the second member in a front-on collision.

According to the vehicle front section structure of the second aspect, collision load input to the first member can be even more efficiently transmitted to the second member in a front-on collision.

According to the vehicle front section structure of the third aspect, collision load can be transmitted to the second member from an initial stage when collision load is input to the first member.

The vehicle front section structure of the fourth aspect enables good joining of the first member that is formed in a hollow rectangular column shape to the second member.

According to the vehicle front section structure of the fifth aspect, the stopper can be easily formed to the second member.

According to the vehicle front section structure of the sixth aspect, collision load input to the first member can be efficiently transmitted to the second member in a front-on collision of the vehicle, even when the first member is formed by extrusion molding.

According to the vehicle front section structure of the seventh aspect, collision load input to the front side members can be efficiently transmitted to the rear members.

According to the vehicle front section structure of the eighth aspect, collision load input to the suspension member front portion can be efficiently transmitted to the suspension member rear portion.

### BRIEF DESCRIPTION OF THE DRAWINGS

Exemplary embodiments of the present disclosure will be described in detail based on the following figures, wherein:

FIG. 1 is a schematic cross-section illustrating the periphery of a rear end portion of a front side member of a vehicle applied with a vehicle front section structure of a first exemplary embodiment in a cutaway state, as viewed from a diagonal left front side of the vehicle;

FIG. 2 is a schematic perspective view illustrating the entirety of a front side member and rear member of a vehicle applied with a vehicle front section structure of the first exemplary embodiment, as viewed from a diagonal left front side of the vehicle;

FIG. 3 is a partially cut away side view illustrating a rear end portion of the front side member, and the rear member, illustrated in FIG. 2;

FIG. 4A is a cross-section (a cross-section along line 4A-4A in FIG. 3) illustrating the periphery of a rear end portion of the front side member illustrated in FIG. 3, as viewed from the upper side;

FIG. 4B is a cross-section (a cross-section along line 4B-4B in FIG. 3) illustrating a kick-up portion of the rear member illustrated in FIG. 3, as viewed along the length direction of the rear member; and

FIG. 5 is an exploded perspective view illustrating a suspension member of a vehicle applied with a vehicle front section structure of a second exemplary embodiment, as viewed from a diagonal left front side of the vehicle.

### DETAILED DESCRIPTION

### First Exemplary Embodiment

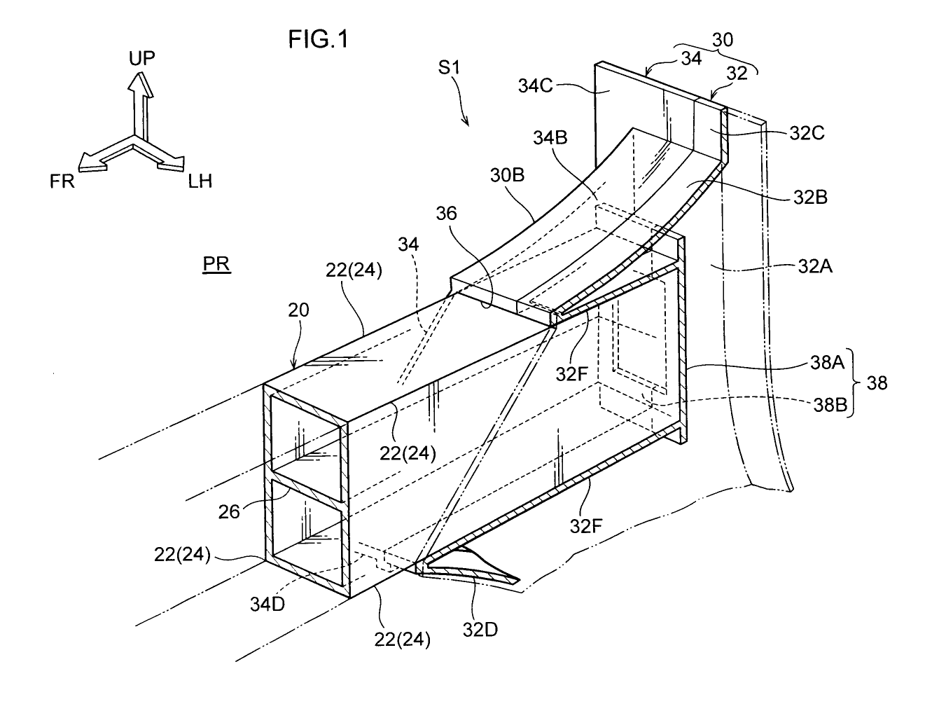

Explanation follows regarding a front section of a vehicle (car) V applied with a vehicle front section structure S1 according to a first exemplary embodiment, with reference to FIG. 1 to FIGS. 4. In the drawings, the arrow FR indicates the front of the vehicle, the arrow UP indicates the top of the vehicle, and the arrow LH indicates the left of the vehicle (one side in the vehicle width direction), as appropriate. In the following explanation, unless specifically stated otherwise, reference to simply the front-rear, vertical, and left-right directions refers to the front and rear in the vehicle front-rear direction, up and down in the vehicle vertical direction, and the left and right of the vehicle (when facing forward).

The vehicle front section structure S1 is configured with left-right symmetry in the vehicle width direction, and so explanation is only given regarding a vehicle left side portion of the front section of the vehicle V. Explanation regarding a vehicle right side portion of the front section of the vehicle V is omitted.

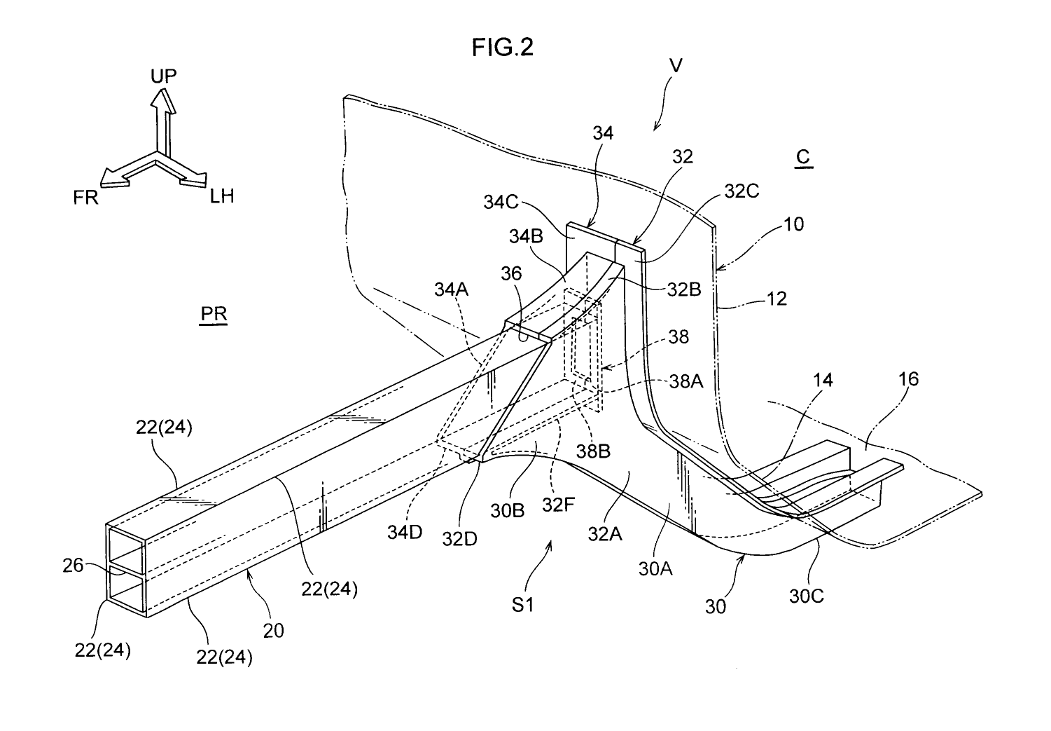

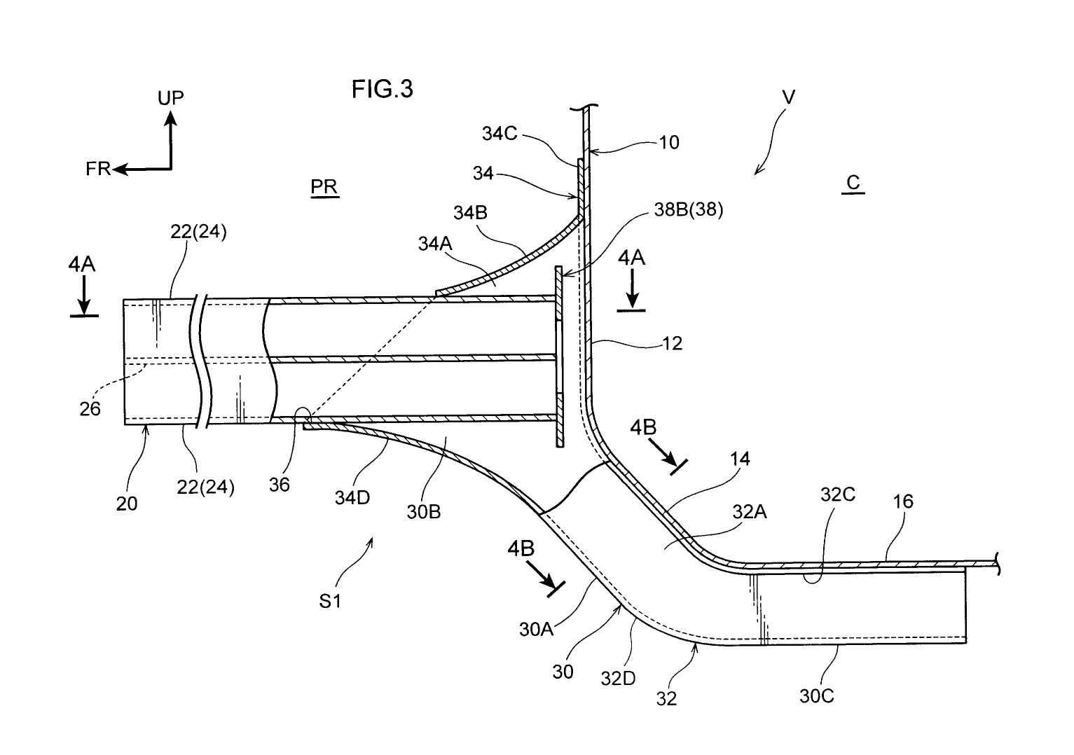

As illustrated in FIG. 2 and FIG. 3, a power unit chamber (engine room) PR is provided in the front section of the vehicle V, and the power unit chamber PR is partitioned from a vehicle cabin C by a dash panel 10. The dash panel 10 is manufactured from sheet steel, and is configured including a panel main body 12 disposed with its plate thickness direction substantially along the front-rear direction, and an inclined portion 14 inclined toward the rear side on progression from a lower end of the panel main body 12 toward the lower side as viewed from the side. A lower end portion of the dash panel 10 is joined by welding or the like to a front end portion of a floor panel 16 that configures the underfloor of the vehicle cabin C. Note that a join portion between the dash panel 10 and the floor panel 16 is omitted from illustration in FIG. 2 and FIG. 3.

Front side members 20, serving as “first members” and configuring framework members of the vehicle V, are provided on both vehicle width direction sides of the power unit chamber PR. The front side members 20 are formed in hollow, rectangular column shapes, and are disposed with their length direction running along the front-rear direction at a front side of a lower end portion of the panel main body 12. Respective ridge lines 24 extending along the front-rear direction are formed at corner portions 22 at four locations on each front side member 20. The front side members 20 are configured from a metal material such as an aluminum alloy, and are formed by extrusion molding. The front side members 20 are therefore not formed with flanges at their front end portions and rear end portions.

A plate shaped reinforcement rib 26 is integrally formed inside each front side member 20. The reinforcement rib 26 is disposed with its plate thickness direction along the vertical direction, and couples together a pair of side walls of the front side member 20. The cross-section structure of the front side member 20 is thus configured as a cross-section structure in which plural substantially rectangular shaped closed cross-sections (two in the present exemplary embodiment) are disposed in a row in the vertical direction. Namely, the reinforcement rib 26 is formed at a single location inside the front side member 20 in the present exemplary embodiment.

A rear member 30, serving as a “second member”, is provided at a rear side of each front side member 20. Each rear member 30 is configured as a hollow structural body with a substantially rectangular shaped closed cross-section, is formed in a substantially crank shape as viewed from the side, and extends along the front-rear direction. Specifically, the rear member 30 includes a kick-up section 30A, the kick-up section 30A inclined toward the lower side on progression toward the rear side so as to follow a front face (power unit chamber PR side face) of the inclined portion 14 of the dash panel 10 as viewed from the side. An upper end portion of the kick-up section 30A is bent toward the front side, and the bent portion configures a rear member front end portion 30B. The rear member front end portion 30B configures a front end portion of the rear member 30, and is disposed adjacent to a front side of the lower end portion of the panel main body 12. A lower end portion of the kick-up section 30A is bent toward the rear side so as to follow the floor panel 16, and the bent portion configures a rear member rear end portion 30C. The rear member rear end portion 30C configures a rear end portion of the rear member 30, and is disposed adjacent to a lower side of the floor panel 16.

The rear member front end portion 30B is penetrated along the front-rear direction, and a rear end portion of the front side member 20 is disposed inside the rear member front end portion 30B and fixed to the rear member front end portion 30B. Specific explanation follows regarding configuration of the rear member 30.

As illustrated in FIG. 2, the rear member 30 is configured with a two-part left-right structure. Namely, the rear member 30 is configured including a rear member outer 32 configuring a vehicle width direction outside portion of the rear member 30, and a rear member inner 34 configuring a vehicle width direction inside portion of the rear member 30. The rear member outer 32 and the rear member inner 34 are each configured from a metal material such as an aluminum alloy, and are formed by die casting.

The rear member outer 32 is configured with an open cross-section profile opening toward the vehicle width direction inside. Specifically, the rear member outer 32 includes a side wall 32A configuring a wall on the vehicle width direction outside of the rear member 30. The side wall 32A is disposed with its plate thickness direction substantially along the vehicle width direction, is bent substantially into a crank shape so as to follow a lower portion of the dash panel 10 as viewed from the side, and extends along the front-rear direction. A front end of a portion of the side wall 32A configuring the rear member front end portion 30B is inclined toward the rear side on progression toward the upper side as viewed from the side.

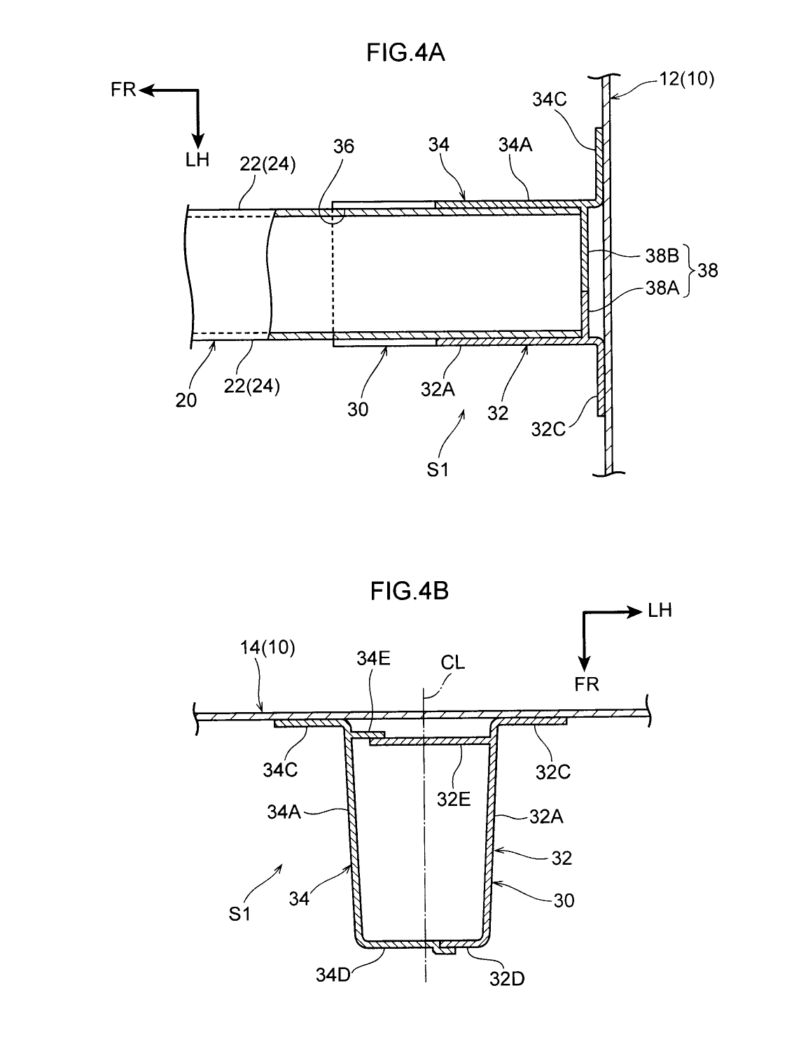

As illustrated in FIG. 1, the rear member outer 32 includes an upper wall 32B, and the upper wall 32B extends from an upper end of the side wall 32A toward the vehicle width direction inside. The upper wall 32B is inclined toward the upper side on progression toward the rear side as viewed from the side, and is curved in a substantially circular arc shape bulging toward a diagonal rear lower side. The extension length of the upper wall 32B is set relatively short, and a leading end of the upper wall 32B is disposed at the vehicle width direction outside (on the side wall 32A side) of a vehicle width direction center line CL (see FIG. 4B) of the rear member 30.

The rear member outer 32 further includes an outer side flange 32C that is joined to the dash panel 10. The outer side flange 32C extends from one width direction end of the side wall 32A (the end on the dash panel 10 side) toward the vehicle width direction outside, and extends out from an upper end of the upper wall 32B toward the upper side, and is disposed facing a front face of the dash panel 10. The outer side flange 32C is joined to the dash panel 10 by self-piercing rivets (SPR), bolts, or the like.

As illustrated in FIG. 4B, the rear member outer 32 includes a first wall 32D. The first wall 32D extends out from a width direction other end of the side wall 32A (the end on the opposite side to the dash panel 10) toward the vehicle width direction inside. The extension length of the first wall 32D is set substantially the same as the extension length of the upper wall 32B, and a leading end of the first wall 32D is disposed on the vehicle width direction outside of the vehicle width direction center line of the rear member 30. As illustrated in FIG. 2, a front end portion of the first wall 32D is curved in a curved line shape toward the front side as viewed from the side, such that its plate thickness direction is disposed substantially in the vertical direction. A rear end portion of the first wall 32D is curved in a curved line shape toward the rear side as viewed from the side, such that its plate thickness direction is disposed substantially in the vertical direction.

As illustrated in FIG. 4B, a second wall 32E is formed at one width direction end side of the side wall 32A at a portion configuring the kick-up section 30A and the rear member rear end portion 30C. The second wall 32E extends out from the side wall 32A toward the vehicle width direction inside, and is disposed facing the front face of the dash panel 10. The extension length of the second wall 32E is set longer than the extension length of the upper wall 32B, and a leading end of the second wall 32E is disposed on the vehicle width direction inside of the vehicle width direction center line CL of the rear member 30.

As illustrated in FIG. 1, the side wall 32A of the rear member outer 32 is integrally formed with a pair of upper and lower inside walls 32F at a portion configuring the rear member front end portion 30B. The inside walls 32F project out from the side wall 32A toward the vehicle width direction inside, and are disposed with their plate thickness direction along the vertical direction, and at a specific separation to each other in the vertical direction. Specifically, the rear end portion of the front side member 20 is interposed between the pair of inside walls 32F in the vertical direction.

As illustrated in FIG. 2 and FIG. 4B, the rear member inner 34 is configured with an open cross-section profile open toward the vehicle width direction outside, and is substantially configured with left-right symmetry to the rear member outer 32. Namely, the rear member inner 34 is configured including a side wall 34A configuring a vehicle width direction inside wall of the rear member 30, an upper wall 34B extending out from an upper end of the side wall 34A toward the vehicle width direction outside, an inner side flange 34C extending out from one width direction end of the side wall 34A toward the vehicle width direction inside, a first wall 34D extending out from the other width direction end of the side wall 34A toward the vehicle width direction outside, and a second wall 34E extending out from the one width direction end side of the side wall 34A toward the vehicle width direction outside. The rear member inner 34 does not include walls corresponding to the inside walls 32F of the rear member outer 32.

The inner side flange 34C is joined to the dash panel 10 by self-piercing rivets (SPR), bolts, or the like. As illustrated in FIG. 1, a leading end of the upper wall 34B of the rear member inner 34 and a leading end of the upper wall 32B of the rear member outer 32 mentioned above are disposed facing each other in the left-right direction, and the upper wall 34B and the upper wall 32B are joined together by MIG welding or the like.

As illustrated in FIG. 4B, the first wall 34D extends out from the side wall 34A such that a leading end portion of the first wall 34D of the rear member inner 34 is disposed at the front side of a leading end portion of the first wall 32D of the rear member outer 32. The first wall 34D and the first wall 32D are joined together by MIG welding or the like in a superimposed state along their plate thickness directions. The rear member front end portion 30B is thus formed with a rectangular shaped opening 36 opening toward the front side. The size of the opening 36 is set slightly larger than the outer profile of the front side member 20.

The second wall 34E extends out from the side wall 34A such that a leading end portion of the second wall 34E of the rear member inner 34 is disposed at the rear side of a leading end portion of the second wall 32E of the rear member outer 32. The second wall 34E and the second wall 32E are joined together by MIG welding or the like in a superimposed state along their plate thickness directions. The kick-up section 30A and the rear member rear end portion 30C are thus configured with a rectangular shaped closed cross-section profile as viewed along the length direction of the rear member 30.

As illustrated in FIG. 1, the rear end portion of the front side member 20 is inserted inside the opening 36 of the rear member 30 from the front side, and is disposed inside the rear member front end portion 30B. In other words, the rear end portion of the front side member 20 is interposed between the rear member outer 32 and the rear member inner 34 in the left-right direction, and the front side member 20 extends out from the opening 36 of the rear member front end portion 30B toward the front side. Outer peripheral portions of the rear end portion of the front side member 20 and edge portions of the opening 36 of the rear member 30 are joined together by MIG welding around the entire periphery of the opening 36 of the rear member 30. Outer peripheral portions of the rear end portion of the front side member 20 and leading end edge portions of the pair of inside walls 32F of the rear member outer 32 are also joined together by MIG welding. The rear end portion of the front side member 20 is thereby fixed to the front end portion of the rear member 30. The rear end of the front side member 20 is disposed inside the rear member front end portion 30B in the fixed state of the front side member 20 to the rear member 30. Namely, the rear end of the front side member 20 is disposed at the front side of the dash panel 10.

Next, explanation follows regarding a stopper wall 38 that serves as a “stopper”, this being a relevant portion of the present disclosure. As illustrated in FIG. 1, the stopper wall 38 is integrally formed at an inner peripheral portion of the rear member front end portion 30B of the rear member 30. The stopper wall 38 is formed substantially in a rectangular frame shape as viewed face-on, and is disposed with its plate thickness direction along the front-rear direction, so as to face the rear end of the front side member 20 along the front-rear direction. Namely, the four corner portions 22 forming the ridge lines 24 of the front side member 20 are covered from the rear side by the stopper wall 38 at the rear end of the front side member 20. As described above, the rear member 30 is configured in a two-part left-right structure by the rear member outer 32 and the rear member inner 34, and so the stopper wall 38 is likewise divided between left and right. Namely, the stopper wall 38 is configured from a stopper outer portion 38A that projects out from the side wall 32A of the rear member outer 32 toward the vehicle width direction inside, and a stopper inner portion 38B that projects out from the side wall 34A of the rear member inner 34 of the rear member 30 toward the vehicle width direction outside. The stopper wall 38 is configured with a substantially rectangular frame shape overall.

The rear end of the front side member 20 is set abutting a front face of the stopper wall 38 in the joined state of the front side member 20 to the rear member 30 (see FIG. 4A). Namely, the rear member 30 is configured to support the front side member 20 from the rear side at the location of the stopper wall 38. Configuration is accordingly made such that the stopper wall 38 bears collision load when the front side member 20 is input with collision load toward the rear side.

Next, explanation follows regarding operation of the first exemplary embodiment.

In the vehicle V applied with the vehicle front section structure S1 configured as described above, the rear end portion of each front side member 20 is fixed to the rear member front end portion 30B of the rear member 30. When the vehicle V is involved in a front-on collision, the front side member 20 is input with collision load toward the rear side, and this collision load is transmitted to the rear member 30. Since the front side member 20 is formed in a hollow rectangular column shape, the collision load is transmitted toward the rear side mainly along the ridge lines 24 of the front side member 20.

The rear member 30 is provided with the stopper wall 38, and the stopper wall 38 covers (supports) the four corner portions 22 from the rear side at the rear end of the front side member 20. The stopper wall 38 accordingly bears the collision load transmitted toward the rear side along the ridge lines 24 of the front side member 20, such that the collision load is transmitted favorably (reliably) to the rear member 30. This thereby enables efficient transmission of collision load input to the front side member 20 to the rear member 30.

The stopper wall 38 covers the four corner portions 22 from the rear side at the rear end of the front side member 20. The front side member 20 can accordingly be supported from the rear side by the stopper wall 38, even when the joined state between the front side member 20 and the rear member 30 has decoupled. Collision load can accordingly be transmitted through the stopper wall 38 to the rear member 30 even in such cases, while the stopper wall 38 also restricts movement of the front side member 20 toward the rear side. The front side member 20 can accordingly be suppressed or prevented from contacting the dash panel 10 in a front-on collision of the vehicle V, thereby enabling the front side member 20 to be suppressed or prevented from intruding into the vehicle cabin C side.

The rear end of the front side member 20 is disposed abutting the front face of the stopper wall 38. This thereby enables collision load to be transmitted to the rear member 30 from an initial stage when the front side member 20 is input with collision load toward the rear side.

The outer peripheral portions of the rear end portion of the front side member 20 and the edge portions of the opening 36 of the rear member 30 are joined together by MIG welding around the entire periphery of the opening 36 of the rear member 30. The outer peripheral portions of the rear end portion of the front side member 20 and leading end edge portions of the pair of inside walls 32F of the rear member outer 32 are also joined together by MIG welding. This thereby enables continuous joins between the rear end portion of the front side member 20 and the front end portion of the rear member 30. This thereby enables good joining (fixing) of the rear end portion of the front side member 20 that is formed in a hollow rectangular column shape to the front end portion of the rear member 30.

The rear member 30 is formed by die casting. The stopper wall 38 can thus be easily formed to the rear member 30 (the rear member outer 32 and the rear member inner 34). Moreover, the stopper wall 38 is integrally formed to the rear member 30, such that the stopper wall 38 functions as a reinforcement rib of the rear member 30. The rigidity of the location of the rear member 30 to which the front side member 20 is fixed (namely, the rear member front end portion 30B) can accordingly be increased, thereby enabling the rigidity of the rear end portion (a base portion) of the front side member 20 to be increased.

The front side member 20 is formed by extrusion molding of an aluminum alloy or the like. Collision load input to the front side member 20 in a front-on collision can accordingly be efficiently transmitted to the rear member 30 even when the front side member 20 is formed by extrusion molding. Namely, generally speaking, in cases in which a rear end portion of a front side member 20 is fixed to a front end portion of a rear member 30, flanges or the like are formed to both members as in the related art, and the respective flanges are joined together. The rear member 30 can accordingly support the front side member 20 from the rear side. On the other hand, when forming the front side member 20 by extrusion molding, it is not possible to form such flanges at the front end and rear end of the front side member 20. Providing the rear member 30 with the stopper wall 38 enables a configuration in which the front side member 20 is supported from the rear side by the stopper wall 38, even in the thus configured front side member 20. Accordingly, collision load input to the front side member 20 in a front-on collision can be efficiently transmitted to the rear member 30, even when the front side member 20 is formed by extrusion molding.

The rear end portion of the front side member 20 is interposed in the vertical direction between the pair of upper and lower inside walls 32F formed to the rear member 30. The rear member 30 can accordingly provide the front side member 20 with increased support rigidity in the vertical direction.

### Second Exemplary Embodiment

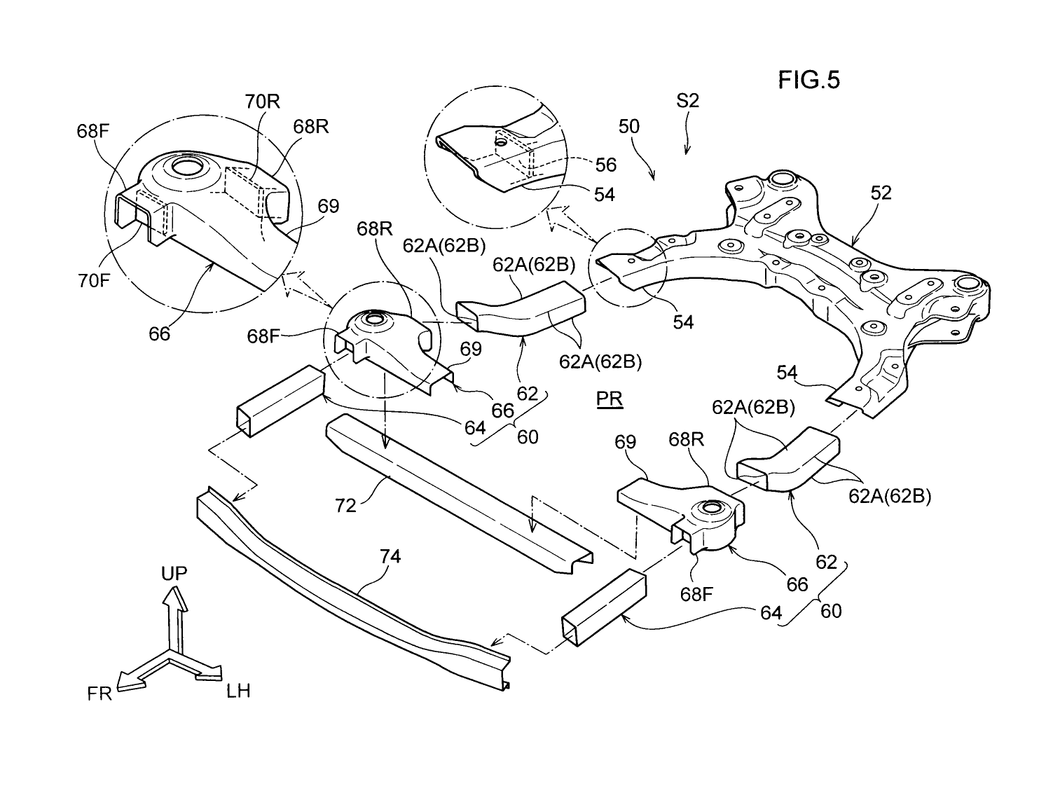

Explanation follows regarding a vehicle front section structure S2 according to a second exemplary embodiment, with reference to FIG. 5. The vehicle front section structure S2 of the second exemplary embodiment is applied to a suspension member 50 disposed at a lower portion of the power unit chamber PR, and the suspension member 50 is disposed between the pair of left and right front side members 20 (not illustrated in FIG. 5) in plan view. Explanation follows regarding configuration of the suspension member 50.

The suspension member 50 is configured including a suspension member rear portion 52, serving as a “second member”, configuring a rear portion of the suspension member 50, a suspension member front portion 74 configuring a front portion of the suspension member 50, and a pair of left and right coupling sections 60 that couple the suspension member rear portion 52 and the suspension member front portion 74 together.

The suspension member rear portion 52 is configured from a metal material such as an aluminum alloy, and is formed by die casting. The suspension member rear portion 52 is configured with an open cross-section profile opening toward the lower side, and is formed substantially in a U-shape opening toward the front side in plan view. A pair of left and right arms 54 are formed projecting out toward the front side at portions on both vehicle width direction sides of the suspension member rear portion 52. The arms 54 configure front end portions of the suspension member rear portion 52, are open toward the front side, and are configured substantially in recessed shapes open toward the lower side as viewed from the front side. A first stopper wall 56, serving as a “stopper”, is integrally provided inside each arm 54, and each first stopper wall 56 is formed substantially in a rectangular plate shape and is disposed with its plate thickness direction along the front-rear direction.

Each coupling section 60 is configured including a first coupling member 62, serving as a “first member” and a “coupling member” and configuring a rear portion of the coupling section 60, a second coupling member 64 configuring a front portion of the coupling section 60, and a coupling bracket 66 that couples the first coupling member 62 and the second coupling member 64 together.

The first coupling member 62 is formed by extrusion molding of a metal material such as an aluminum alloy. The first coupling member 62 is formed in a hollow rectangular column shape, and extends along the front-rear direction. Respective ridge lines 62B are accordingly formed extending along the front-rear direction at corner portions 62A at four locations on each first coupling member 62. A front end portion of the first coupling member 62 is bent substantially into a crank shape, and a rear end portion of the first coupling member 62 is disposed further to the lower side than the front end portion of the first coupling member 62. The rear end portion of the first coupling member 62 is disposed inside the corresponding arm 54 of the suspension member rear portion 52, and opening edge portions of the arm 54 are joined to outer peripheral portions of the first coupling member 62 by MIG welding. A rear end of the first coupling member 62 abuts a front face of the first stopper wall 56, and the first stopper wall 56 covers the corner portions 62A of the first coupling member 62 from the rear side at the rear end of the first coupling member 62.

The second coupling member 64 is formed by extrusion molding of a metal material such as an aluminum alloy, similarly to the first coupling member 62. The second coupling member 64 is formed in a hollow rectangular column shape, and extends along the front-rear direction. Respective ridge lines 64B are accordingly formed extending along the front-rear direction at corner portions 64A at four locations on each second coupling member 64.

The coupling bracket 66 is configured from a metal material such as an aluminum alloy, and is formed by die casting. The coupling bracket 66 is formed with an open cross-section profile opening toward the lower side, and is formed substantially in a T-shape projecting out toward the vehicle width direction inside in plan view. Specifically, the coupling bracket 66 is integrally formed with a pair of front and rear first connection portions 68F, 68R projecting out along the front-rear direction. The first connection portion 68F is open toward the front side, and the first connection portion 68R is open toward the rear side, and the first connection portions 68F, 68R are formed substantially in recessed shapes opening toward the lower side as viewed along the front-rear direction. Respective second stopper walls 70F, 70R are integrally provided inside the first connection portions 68F, 68R, and the second stopper walls 70F, 70R are formed substantially in rectangular plate shapes, re respectively disposed with their thickness direction along the front-rear direction.

A front end portion of the first coupling member 62 is disposed inside the first connection portion 68R, and opening edge portions of the first connection portion 68R are joined to outer peripheral portions of the first coupling member 62 by MIG welding. A front end of the first coupling member 62 abuts a rear face of the second stopper wall 70R, and the second stopper wall 70R covers the corner portions 62A of the first coupling member 62 from the front side at the front end of the first coupling member 62.

A rear end portion of the second coupling member 64 is disposed inside the first connection portion 68F, and opening edge portions of the first connection portion 68F are joined to outer peripheral portions of the second coupling member 64 by MIG welding. A rear end of the second coupling member 64 abuts a front face of the second stopper wall 70F, and the second stopper wall 70F covers the corner portions 64A of the second coupling member 64 from the rear side at the rear end of the second coupling member 64.

The coupling bracket 66 is integrally formed with a second connection portion 69 projecting out toward the vehicle width direction inside. The second connection portion 69 opens toward the vehicle width direction inside, and is formed substantially in a recessed shape opening toward the lower side as viewed from the vehicle width direction inside. An elongated intermediate member 72 with its length direction along the vehicle width direction is provided between the pair of coupling brackets 66. The intermediate member 72 is formed by extrusion molding of a metal material such as an aluminum alloy, and is formed substantially in a recessed shape opening toward the lower side as viewed along the vehicle width direction. Both length direction end portions of the intermediate member 72 are disposed inside the respective second connection portions 69, and opening edge portions of each second connection portion 69 are joined to outer peripheral portions of each length direction end portion of the intermediate member 72 by MIG welding.

The suspension member front portion 74 is configured in an elongated shape with its length direction along the vehicle width direction, and is formed substantially in a recessed shape opening toward the rear side as viewed along the vehicle width direction. The suspension member front portion 74 is configured from a metal material such as an aluminum alloy, and is formed by die casting. A front end portion of each second coupling member 64 is disposed inside a corresponding length direction end portion of the suspension member front portion 74, and opening edge portions of the suspension member front portion 74 are joined to outer peripheral portions at the front end portion of each second coupling member 64 by MIG welding.

In the suspension member 50 configured as described above, when collision load toward the rear side is input to the suspension member front portion 74 in a front-on collision of the vehicle V, the collision load is transmitted through the coupling section 60 (the second coupling member 64, the coupling bracket 66, and the first coupling member 62) to the suspension member rear portion 52.

Specifically, collision load is input to the second coupling member 64 through the suspension member front portion 74, and the collision load is mainly transmitted toward the rear side along the ridge lines 64B of the second coupling member 64. The collision load transmitted toward the rear side along the ridge lines 64B of the second coupling member 64 is borne by the second stopper wall 70F, and the collision load is favorably transmitted to the coupling bracket 66.

The collision load transmitted to the coupling bracket 66 is input to the first coupling member 62 through the second stopper wall 70R. The collision load input to the first coupling member 62 is mainly transmitted toward the rear side along the ridge lines 62B of the first coupling member 62. The collision load transmitted toward the rear side along the ridge lines 62B of the first coupling member 62 is then borne by the first stopper wall 56, and the collision load is favorably transmitted to the suspension member rear portion 52. This thereby enables efficient transmission of collision load input to the first coupling member 62 to the suspension member rear portion 52 in the second exemplary embodiment.

Note that in the second exemplary embodiment, the rear end of the second coupling member 64 abuts the front face of the second stopper wall 70F, and the second stopper wall 70F covers the corner portions 64A of the second coupling member 64 from the rear side at the rear end of the second coupling member 64. The second coupling member 64 accordingly may serve as a “first member” and “coupling member” of the present disclosure, the coupling bracket 66 may serve as a “second member” of the present disclosure, and the second stopper wall 70F may serve as a “stopper” of the present disclosure.

In the first exemplary embodiment, the stopper wall 38 of the rear member 30 covers the four corner portions 22 of the front side member 20 from the rear side. In the second exemplary embodiment, the first stopper wall 56 covers the four corner portions 62A of the first coupling member 62 from the rear side. As an alternative, in the first exemplary embodiment, configuration may be made such that the stopper wall 38 covers at least one of the corner portions 22 of the front side member 20 from the rear side. Further, in the second exemplary embodiment, configuration may be made such that the first stopper wall 56 covers at least one of the corner portions 62A of the first coupling member 62 from the rear side.

In the first exemplary embodiment, the rear end of the front side member 20 abuts the stopper wall 38 of the rear member 30, and in the second exemplary embodiment, the rear end of the first coupling member 62 abuts the first stopper wall 56. As an alternative, in the first exemplary embodiment, configuration may be made such that a small gap is formed between the rear end of the front side member 20 and the stopper wall 38. Further, in the second exemplary embodiment, configuration may be made such that a small gap is formed between the rear end of the first coupling member 62 and the first stopper wall 56.

What is claimed is:

1. A vehicle front section structure comprising:
a first member that is configured from a metal material, that is formed in a hollow rectangular column shape, and that is disposed with a length direction along a vehicle front-rear direction at a front section of a vehicle;
a second member that is configured from a metal material, that extends along the vehicle front-rear direction at a vehicle rear side of the first member, and that has a front end portion fixed to a rear end portion of the first member; and
a stopper that is provided at the second member, that is disposed facing a rear end of the first member along the vehicle front-rear direction, and that covers at least one corner portion of the first member from the vehicle rear side.

2. The vehicle front section structure of claim 1, wherein the stopper covers every corner portion of the first member from the vehicle rear side.

3. The vehicle front section structure of claim 1, wherein the rear end of the first member abuts the stopper.

4. The vehicle front section structure of claim 1, wherein the first member and the second member are joined together by MIG welding.

5. The vehicle front section structure of claim 1, wherein the second member is formed by die casting, and the stopper is integrally formed with the second member.

6. The vehicle front section structure of claim 1, wherein the first member is formed by extrusion molding.

7. The vehicle front section structure of claim 1, wherein:
the first member is configured by front side members disposed on both vehicle width direction sides of the front section of the vehicle; and
the second member is configured by rear members extending along the vehicle front-rear direction so as to follow a dash panel partitioning between the front section of the vehicle and a vehicle cabin.

8. The vehicle front section structure of claim 1,
wherein the first member is configured by a coupling member of a suspension member provided at the front section of the vehicle, the suspension member including a suspension member front portion and a suspension member rear portion, and
the second member is configured by the suspension member rear portion, and wherein
the suspension member front portion configuring a front portion of the suspension member;
the suspension member rear portion configuring a rear portion of the suspension member; and
the coupling member coupling the suspension member front portion and the suspension member rear portion together.
